(19) United States
(12) Patent Application Publication
(10) Pub. No.: US 2024/0409754 A1
(43) Pub. Date: Dec. 12, 2024

(54) ANTIFOULING COATING COMPOSITION

(71) Applicant: CHUGOKU MARINE PAINTS, LTD., Otake-shi (JP)

(72) Inventors: Shotaro HARADA, Otake-shi (JP); Junnai IKADAI, Otake-shi (JP); Shuya NAKAMURA, Otake-shi (JP)

(73) Assignee: CHUGOKU MARINE PAINTS, LTD., Otake-shi (JP)

(21) Appl. No.: 18/672,285

(22) Filed: May 23, 2024

(30) Foreign Application Priority Data
May 31, 2023 (JP) 2023-089669

(51) Int. Cl. C09D 5/16; C09D 7/41; C09D 7/61; C09D 7/63

(52) U.S. Cl. CPC C09D 5/1675; C09D 7/61; C09D 7/63; C09D 7/41

(57) ABSTRACT

An antifouling coating composition contains a silyl ester-based polymer and water, wherein the silyl ester-based polymer has a triorganosilyl group, the antifouling coating composition has a volatile organic compound (VOC) content of 100 g/L or less, an oxyalkylene unit is present in the antifouling coating composition, and a molar ratio ((a) (b)) of a triorganosilyl group (a) to an oxyalkylene unit (b) measured by ¹³C-NMR with respect to the antifouling coating composition is 40.0:60.0 to 48.5:51.5.

### CROSS-REFERENCE TO RELATED APPLICATION

The present application claims the priority from Japanese Patent Application No. 2023-089669 filed on May 31, 2023, which is incorporated herein by reference in their entirety.

### BACKGROUND OF THE INVENTION

### Field of the Invention

The present disclosure relates to an antifouling coating composition, an antifouling coating film, an antifouling substrate, and a method for producing an antifouling substrate.

### Description of the Related Art

Conventionally, organic solvent diluted resins such as oil type resins, vinyl type resins, acrylic resins, and chlorinated rubber type resins are used as a resin constituting an antifouling coating composition. In recent years, a waterborne antifouling coating composition having a low volatile organic compound (VOC) content has been developed (see, for example, WO 2005/116155 A, JP 2003-277680 A, and JP 2006-052284 A.) from the viewpoint of environmental conservation and improvement of a coating work environment.

### SUMMARY OF THE INVENTION

In designing a waterborne antifouling coating composition, it is known that there are various methods for making a resin aqueous. However, a conventional waterborne antifouling coating composition is difficult to have both storage stability and an antifouling property. An object of the present disclosure is to provide a waterborne antifouling coating composition that is excellent in storage stability and can form a coating film excellent in the antifouling property.

The present inventors have found that the above problem can be solved by an antifouling coating composition containing the following components. That is, the antifouling coating composition of the present disclosure is, in one embodiment, an antifouling coating composition containing a silyl ester-based polymer and water, in which the silyl ester-based polymer has a triorganosilyl group, the antifouling coating composition has a volatile organic compound (VOC) content of 100 g/L or less, and an oxyalkylene unit is present in the antifouling coating composition, and a molar ratio ((a):(b)) of a triorganosilyl group (a) to an oxyalkylene unit (b) measured by ¹³C-NMR (nuclear magnetic resonance spectroscopy) with respect to the antifouling coating composition is 40.0:60.0 to 48.5:51.5.

According to the present disclosure, a waterborne antifouling coating composition that is excellent in storage stability and can form a coating film excellent in the antifouling property, can be provided.

### DESCRIPTION OF EMBODIMENTS

Hereinafter, an embodiment of the present disclosure will be described in detail.

One or two or more of each component described in the present specification can be used.

The term “polymer” is used as a meaning encompassing a homopolymer and a copolymer.

The term “(meth) acrylate” is a general term for acrylate and methacrylate. The same applies to, for example, (meth) acrylic acid.

The term “poly (oxyalkylene)” is also referred to as “polyoxyalkylene”. For example, the term “poly (oxyethylene)” is also referred to as “polyoxyethylene”.

In the present disclosure, numerical range n1 to n2 means n1 or more and n2 or less. Here, n1 and n2 are arbitrary numbers satisfying n1<n2. In the present disclosure, when a plurality of lower limit values and a plurality of upper limit values are described for a certain element, a numerical range obtained by combining a value arbitrarily selected from the described upper limit values and a value arbitrarily selected from the described lower limit values is also assumed to be described.

The term “structural unit derived from XX” is, for example, a structural unit represented by the following Formula where XX is represented by A¹A²C=CA³A⁴ (C═C is a polymerizable carbon-carbon double bond, and A¹ to A⁴ are each an atom or a group bonded to a carbon atom.).

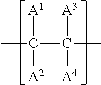

### [Antifouling Coating Composition]

The antifouling coating composition of the present disclosure (hereinafter also referred to as “composition of the present disclosure”) contains a silyl ester-based polymer described below and water. The silyl ester-based polymer has a triorganosilyl group.

A volatile organic compound (VOC) content in the composition of the present disclosure is preferably 100 g/L or less, more preferably 90 g/L or less, still more preferably 80 g/L or less, further more preferably 70 g/L or less, and particularly preferably 60 g/L or less.

Examples of the VOC include organic solvents. Examples of the organic solvent include aromatic hydrocarbon-based-solventssuch as toluene, o-xylene, m-xylene, p-xylene, Cethylbenzene, and mesitylene; alcohol-based solvents such as ethanol, propanol, isopropyl alcohol, butanol and isobutanol; ether-based solvents such as propylene glycol monomethyl ether and dipropylene glycol monomethyl ether; ketone-based solvents such as methyl ethyl ketone, methyl isobutyl ketone, methyl amyl ketone, and cyclohexanone; and ester-based solvents such as ethyl acetate, butyl acetate and propylene glycol monomethyl ether acetate.

The VOC content in the composition of the present disclosure is preferably as low as possible, but the content may be, for example, 1 g/L or more, 5 g/L or more, 10 g/L or more, 20 g/L or more, or 30 g/L or more. The VOC content in the composition of the present disclosure may be, for example, 1 to 100 g/L.

In the present disclosure, the VOC content in the composition is calculated based on the following Formula (1) using the following values of a composition specific gravity, a solid content concentration, and a moisture concentration.

$$VOC content ( g / L ) = Composition specific gravity \times 1000 \times ( 100 - solid content concentration - moisture concentration ) / 100 \qquad ( 1 )$$

The composition specific gravity (g/mL) is a value calculated by filling a specific gravity cup having an internal volume of 100 mL with the composition under a temperature condition of 23° C. and measuring the mass of the composition.

The solid content concentration (mass %) is a value calculated by a method described in the Example section described later. In the present disclosure, the solid content of the composition means a heating residue when the composition is dried in a thermostatic chamber at 108° C. for 3 hours, as described in the Example section described later. Similarly, the solid content of each component (for example, aqueous dispersion) means a heating residue when each component is dried in the thermostatic chamber at 108° C. for 3 hours as described in the Example section described later.

The moisture concentration (mass %) is the amount (mass %) of water contained in 100 mass % of the composition, and is measured using a moisture measuring apparatus (for example, CA-310, manufactured by Nittoseiko Analytech Co., Ltd.) according to the Karl Fischer method.

In the composition of the present disclosure, a triorganosilyl group is present. The triorganosilyl group is, for example, a triorganosilyl group contained in the silyl ester-based polymer. The triorganosilyl group is, for example, a silyl group represented by —SiR₃, and each R is independently a monovalent organic group having 1 to 20 carbon atoms optionally having a hetero atom, provided that an atom bonded to the silicon atom (Si) contained in the silyl group in the organic group is a carbon atom (silicon-bonded carbon atom (Si—C)). Examples of the monovalent organic group having 1 to 20 carbon atoms optionally having a hetero atom include specific examples described later. The triorganosilyl group is preferably a trialkylsilyl group, and more preferably a triisopropylsilyl group.

In the composition of the present disclosure, an oxyalkylene unit is present.

In the present disclosure, the oxyalkylene unit (also referred to as an alkyleneoxy unit) means a unit represented by —O-A- derived from alkylene glycol. In the Formula, A represents an alkanediyl group. The number of carbon atoms in the alkanediyl group is preferably 2 or more, and is preferably 10 or less, more preferably 8 or less, still more preferably 6 or less, and particularly preferably 4 or less, and is, for example, 2 to 10. As the alkanediyl group, specifically, an ethanediyl group and a propanediyl group are preferable. That is, as the oxyalkylene unit, an oxyethylene unit and an oxypropylene unit are preferable.

The oxyalkylene unit is preferably a repeating unit. That is, the solid content of the composition of the present disclosure preferably contains a poly (oxyalkylene) structure. In other words, the oxyalkylene unit constitutes the poly (oxyalkylene) structure. Examples of the poly (oxyalkylene) structure include, specifically, a poly (oxyethylene) structure and a poly (oxypropylene) structure.

The oxyalkylene unit in the solid content of the composition may be introduced, for example, by using a silyl ester-based polymer produced by an emulsion polymerization method using a surfactant having the oxyalkylene unit, may be introduced by blending the surfactant having the oxyalkylene unit in the composition, or may be introduced by using these methods in combination. Examples of the surfactant having the oxyalkylene unit include a surfactant having the poly (oxyalkylene) structure, and specific examples thereof will be described later. In the surfactant (for example, a reactive surfactant and a non-reactive surfactant described later), the number of repeating units of the oxyalkylene unit is preferably 2 or more, more preferably 4 or more, still more preferably 6 or more, and particularly preferably 8 or more, and is preferably 20 or less, more preferably 18 or less, still more preferably 16 or less, and particularly preferably 14 or less, and is, for example, 2 or more and 20 or less.

The present inventors have found that even when the VOC is low, an antifouling coating film excellent in an antifouling property (particularly a dynamic antifouling property), crack resistance, and stability of a coating film consumption degree can be formed while the composition is excellent in storage stability, by adjusting the content of the oxyalkylene unit present in the composition of the present disclosure as follows.

A molar ratio ((a):(b)) of the triorganosilyl group (a) to the oxyalkylene unit (b) measured by ¹³C-NMR for the composition of the present disclosure is preferably 40.0:60.0 to 48.5:51.5, more preferably 41.0:59.0 to 48.4:51.6, still more preferably 41.5:58.5 to 48.3:51.7, further more preferably 42.0:58.0 to 48.3:51.7, even further more preferably 43.0:57.0 to 48.3:51.7, and particularly preferably 44.0:56.0 to 48.3:51.7, 45.0:55.0 to 48.3:51.7, 46.0:54.0 to 48.3:51.7, or 47.0:53.0 to 48.3:51.7. The present inventors have found that even when the VOC is low, a composition in which the molar ratio of the oxyalkylene unit is the lower limit value or more is excellent in storage stability. The present inventors have found that even when the VOC is low, a composition in which the molar ratio of the oxyalkylene unit is the upper limit value or less can form an antifouling coating film excellent in the antifouling property (particularly a dynamic antifouling property), crack resistance, and stability of a coating film consumption degree. The triorganosilyl group is preferably the trialkylsilyl group, more preferably the triisopropylsilyl group, and the oxyalkylene unit is preferably at least one selected from the oxyethylene unit and the oxypropylene unit.

In the present disclosure, the dynamic antifouling property means an antifouling property evaluated by a dynamic antifouling property test. The dynamic antifouling property test is, for example, a test in which a water stream is generated using a rotating rotor, the water stream is applied to a surface of an antifouling coating film of a test plate for a certain period of time, and then the antifouling property is evaluated.

In the antifouling coating film made of the composition of the present disclosure, as described later, appropriate renewal of a coating film surface and elution of an antifouling agent used as necessary occur, and the antifouling property is continuously exhibited. In the present disclosure, the stability of the coating film consumption degree means that a consumption rate, that is, a disappearance rate of the coating film is stable over a certain period of time. When the consumption rate of the coating film is not stable, the coating film disappears unexpectedly early and the antifouling property tends to decrease, or elution of the antifouling agent is insufficient and the antifouling property tends to decrease.

In the analysis of the antifouling coating composition by solid ¹³C-NMR, since a characteristic peak in each of the triorganosilyl group and the oxyalkylene unit is observed, the molar ratio is specified from positions of the peaks and an integral ratio (area ratio) of the peaks. The molar ratio is specifically measured as follows.

10 g of the antifouling coating composition is put into a centrifuge tube and 40 g of water is added thereto to be stirred, and then a centrifugal separation treatment is performed at 18° C. A supernatant liquid in the centrifuge tube is heated and dried in an oven under conditions of 125° C., 1 atm, and 1 hour. A sample rotor having an outer diameter of 4 mm is charged with an obtained solid while the obtained solid is swollen with deuterated chloroform, and the solid ¹³C-NMR spectrum (measuring method: dipole decoupling-magic angle spinning method, observation nucleus: ¹³C) is measured. Details of the measurement conditions are described in the Example section.

### (1) Number of Moles of the Triorganosilyl Group (a)

A peak assigned to a silicon-bonded carbon atom (Si—C) contained in the triorganosilyl group is selected in the ¹³C-NMR spectrum, and the number of moles (relative value) of the triorganosilyl group is calculated from the integral ratio (area ratio) of the peak. For example, when the peaks respectively assigned to a plurality of the Si—C contained in the triorganosilyl group overlap each other, the number of moles (relative value) of the triorganosilyl group may be calculated by dividing the area ratio by the number of the Si—C assigned to the overlapped peaks. For example, when three organic groups in the triorganosilyl group are identical, 1/3 of the integral ratio (area ratio) of the peaks assigned to the Si—C contained in the triorganosilyl group is calculated as the number of moles (relative value) of the triorganosilyl group. Specifically, when the triorganosilyl group is the triisopropylsilyl group, a peak is observed around 12 ppm, and the peak corresponds to a peak of a methine carbon in the isopropylsilyl group. Thus, 1/3 of the integral ratio (area ratio) of the peak around 12 ppm is calculated as the number of moles (relative value) of the triisopropylsilyl group. The chemical shift is corrected such that a central peak of a triplet derived from the deuterated chloroform is 77.23 ppm.

### (2) Number of Moles of the Oxyalkylene Unit (b)

A peak assigned to a carbon atom contained in the oxyalkylene unit is selected in the ³C-NMR spectrum, and the number of moles (relative value) of the oxyalkylene unit is calculated from the integral ratio (area ratio) of the peak. For example, when the peaks respectively assigned to a plurality of carbon atoms contained in the oxyalkylene unit overlap each other, the number of moles (relative value) of the oxyalkylene unit may be calculated by dividing the area ratio by the number of the carbon atoms assigned to the overlapped peaks. Specifically, when the oxyalkylene unit has an ethylene glycol structure or a propylene glycol structure, a peak is observed around 70 to 76 ppm, and the peak corresponds to a peak of a methylene carbon of the ethylene glycol structure or peaks of the methylene carbon and the methine carbon of the propylene glycol structure. Thus, 1/2 of the integral ratio (area ratio) of the peak around 70 to 76 ppm is calculated as the number of moles (relative value) of the oxyalkylene unit. The chemical shift is corrected such that a central peak of a triplet derived from the deuterated chloroform is 77.23 ppm.

### (3) Calculation of the Molar Ratio ((a):(b))

The molar ratio ((a):(b)) of the triorganosilyl group (a) to the oxyalkylene unit (b) is calculated from the number of moles of the triorganosilyl group obtained in the above (1) and the number of moles of the oxyalkylene unit obtained in the above (2).

### <Silyl Ester-Based Polymer>

The composition of the present disclosure contains the silyl ester-based polymer. The silyl ester-based polymer is a type of a hydrolyzable resin. The hydrolyzable resin is a resin that is dissolved in seawater as hydrolysis of the resin proceeds by the seawater and exhibits a self-polishing property of the coating film. Thus, in the antifouling coating film made of the composition of the present disclosure, appropriate renewal of a coating film surface and elution of an antifouling agent used as necessary occur, and the antifouling property is continuously exhibited.

The silyl ester-based polymer has the triorganosilyl group such as the trialkylsilyl group. Examples of the silyl ester-based polymer include a polymer including a structural unit (a-1) derived from a polymerizable monomer (a1) represented by the following Formula (a1). The structural unit (a-1) in the silyl ester-based polymer may be one or two or more.

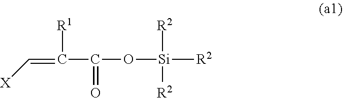

Each symbol in Formula (a1) will be described below.

R¹ is a hydrogen atom or a methyl group, and is preferably the methyl group.

Each R² is independently a monovalent organic group having 1 to 20 carbon atoms optionally having a hetero atom, provided that an atom bonded to the silicon atom (Si) contained in Formula (a1) in the organic group is a carbon atom. Examples of the organic group include linear or branched alkyl groups, cycloalkyl groups, and aryl groups in which a hetero atom such as an oxygen atom optionally interposed between a carbon atom and a carbon atom. The organic group is preferably the linear or branched alkyl groups each having 1 to 8 carbon atoms, and more preferably the branched alkyl groups each having 3 to 8 carbon atoms from the viewpoint of easily forming a coating film excellent in a long-term antifouling property and crack resistance.

Examples of the linear or branched alkyl group include a methyl group, an ethyl group, a propyl group, an isopropyl group, a butyl group, an isobutyl group, a sec-butyl group, a t-butyl group, a pentyl group, a hexyl group, and a 2-ethylhexyl group, and is preferably the isopropyl group.

X is a hydrogen atom or a group represented by R³—O—C(═O)—, and is preferably the hydrogen atom. R³ is a hydrogen atom, a monovalent organic group having 1 to 20 carbon atoms optionally having a hetero atom, or a silyl group represented by (R⁴)3Si—, and is preferably an isopentyl group. Each R⁴ is independently a monovalent organic group having 1 to 20 carbon atoms optionally having a hetero atom, provided that the atom bonded to the silicon atom (Si) contained in the silyl group in the organic group is a carbon atom. Examples of the monovalent organic group having 1 to 20 carbon atoms optionally having a hetero atom include specific examples described above.

As the polymerizable monomer (a1), trialkylsilyl (meth) acrylate, alkyldiarylsilyl (meth) acrylate, and aryldialkylsilyl (meth) acrylate are preferable, and trialkylsilyl (meth) acrylate is more preferable. Examples of the trialkylsilyl (meth) acrylate include trimethylsilyl (meth) acrylate, triethylsilyl (meth) acrylate, tripropylsilyl (meth) acrylate, triisopropylsilyl (meth) acrylate, tributylsilyl (meth) acrylate, triisobutylsilyl (meth) acrylate, tri-sec-butylsilyl (meth) acrylate, tri-2-ethylhexylsilyl (meth) acrylate, and butyldiisopropylsilyl (meth) acrylate. Among them, the trialkylsilyl (meth) acrylate having the branched alkyl group is preferable, the triisopropylsilyl (meth) acrylate is more preferable, and the triisopropylsilyl methacrylate is particularly preferable from the viewpoint of easily forming a coating film excellent in a long-term antifouling property and crack resistance in a well-balanced manner.

The silyl ester-based polymer can further include a structural unit (a-2) derived from another ethylenically unsaturated monomer (hereinafter also referred to as “polymerizable monomer (a2)”) other than the polymerizable monomer (a1). The structural unit (a-2) in the silyl ester-based polymer may be one or two or more.

Examples of the polymerizable monomer (a2) include at least one monomer selected from (meth) acrylic acid and an ester thereof (hereinafter, also referred to as a “(meth) acrylic monomer”), styrene, α-methylstyrene, vinyltoluene, vinyl acetate, vinyl propionate, maleic acid, itaconic acid, (meth) acrylic acid amide, (meth) acrylonitrile, an aliphatic carboxylic acid metal (meth) acrylate, and a reactive surfactant.

Examples of the (meth) acrylic monomer include
(Meth) acrylic acid;
alkyl (meth) acrylates having an alkyl group with 1 to 18 carbon atoms, such as methyl (meth) acrylate, ethyl (meth) acrylate, n-propyl (meth) acrylate, isopropyl (meth) acrylate, n-butyl (meth) acrylate, isobutyl (meth) acrylate, t-butyl (meth) acrylate, n-hexyl (meth) acrylate, 2-ethylhexyl (meth) acrylate, n-octyl (meth) acrylate, decyl (meth) acrylate, lauryl (meth) acrylate, and stearyl (meth) acrylate;
cycloalkyl (meth) acrylates having a cycloalkyl group with 3 to 18 carbon atoms, such as cyclohexyl (meth) acrylate;
aromatic ring-containing (meth) acrylates such as phenyl (meth) acrylate, benzyl (meth) acrylate, and phenoxyethyl (meth) acrylate;
alkoxyalkyl (meth) acrylates having an alkoxyalkyl group with 2 to 18 carbon atoms, such as methoxymethyl (meth) acrylate, methoxyethyl (meth) acrylate, methoxybutyl (meth) acrylate, and ethoxybutyl (meth) acrylate;
hydroxyalkyl (meth) acrylates such as hydroxymethyl (meth) acrylate, 2-hydroxyethyl (meth) acrylate, 2-hydroxypropyl (meth) acrylate and 4-hydroxybutyl (meth) acrylate; dialkylaminoalkyl (meth) acrylates such as dimethylaminoethyl (meth) acrylate and dimethylaminopropyl (meth) acrylate; and
glycidyl (meth) acrylates.

One or two or more of the (meth) acrylic monomers can be used.

The reactive surfactant (also referred to as a reactive emulsifier) refers to a surfactant having a polymerizable unsaturated bond such as an ethylenically unsaturated bond in a molecule. The reactive surfactant may have the poly (oxyalkylene) structure. One or two or more of the reactive surfactants may be used. Examples of the reactive surfactant include an anionic surfactant having a sulfonate group or a sulfuric acid ester salt group, the polymerizable unsaturated bond, and the poly (oxyalkylene) structure in the molecule, and a nonionic surfactant having the poly (oxyalkylene) structure and the polymerizable unsaturated bond in the molecule. Examples of a salt include alkali metal salts such as sodium salts and potassium salts, and ammonium salts. Examples of the reactive surfactant include, specifically, poly (oxyalkylene) polycyclic phenyl ether sulfuric acid ester salts having the polymerizable unsaturated bond in the molecule, and poly (oxyalkylene) polycyclic phenyl ethers having the polymerizable unsaturated bond in the molecule. Examples of a commercially available product of the reactive surfactant include AQUALON series (manufactured by DKS Co. Ltd.), ADEKA REASOAP series (manufactured by ADEKA Corporation), and LATEMUL PD series (manufactured by Kao Corporation).

Examples of the anionic surfactant include poly (oxyalkylene) alkenyl ether sulfuric acid ester salts, poly (oxyalkylene) allylalkyl ether sulfuric acid ester salts, poly (oxyalkylene) alkylallylphenyl ether sulfuric acid ester salts, poly (oxyalkylene) propenylalkyl ether sulfuric acid ester salts, poly (oxyalkylene) alkylpropenylalkyl ether sulfuric acid ester salts, poly (oxyalkylene) alkylpropenylphenyl ether sulfuric acid ester salts, poly (oxyalkylene) allyloxyalkyl ether sulfuric acid ester salts, and poly (oxyalkylene) styrenated propenylphenyl ether sulfuric acid ester salts.

Examples of the nonionic surfactant include poly (oxyalkylene) alkenyl ether, poly (oxyalkylene) allylalkyl ether, poly (oxyalkylene) alkylallylphenyl ether, poly (oxyalkylene) propenylalkyl ether, poly (oxyalkylene) alkylpropenylalkyl ether, poly (oxyalkylene) alkylpropenylphenyl ether, poly (oxyalkylene) allyloxyalkyl ether, and poly (oxyalkylene) styrenated propenylphenyl ether.

One or two or more of the reactive surfactants can be used. For example, a reactive and anionic surfactant and a reactive and nonionic surfactant may be used in combination.

A content ratio of the structural unit (a-1) in the silyl ester-based polymer is preferably 30 mass % or more, more preferably 40 mass % or more, and still more preferably 45 mass % or more, and is preferably 80 mass % or less, more preferably 75 mass % or less, and still more preferably 70 mass % or less, and is, for example, 30 to 80 mass %.

A content ratio of the structural unit (a-2) in the silyl ester-based polymer is preferably 20 mass % or more, more preferably 25 mass % or more, and still more preferably 30 mass % or more, and preferably 70 mass % or less, more preferably 60 mass % or less, and still more preferably 55 mass % or less, and is, for example, 20 to 70 mass %.

When the content ratio of each structural unit is within the above range, the antifouling coating film made of the composition of the present disclosure tends to have moderate hydrolyzability and to be excellent in the long-term antifouling property. The content ratio of each structural unit is measured by NMR.

One or two or more of the silyl ester-based polymers can be used.

The content ratio of the silyl ester-based polymer is preferably 5 mass % or more and more preferably 10 mass % or more, and is preferably 30 mass % or less, more preferably 25 mass % or less, and still more preferably 20 mass % or less, and is, for example, 5 to 30 mass % in 100 mass % of the solid content of the composition of the present disclosure. According to such an aspect, there is a tendency that an antifouling coating film having an appropriate self-polishing property of the coating film surface can be formed. In the present disclosure, the content ratio and content of each component are measured by NMR and infrared spectroscopy (IR). When the measurement is difficult, the content ratio and content of each component can be calculated from a charged amount of each component at the time of preparing the composition.

Examples of a method for producing the silyl ester-based polymer include an emulsion polymerization method, a solution polymerization method, a bulk polymerization method, and a suspension polymerization method. Among them, the emulsion polymerization method is preferable from the viewpoint of easily adjusting the VOC content in the composition to 100 g/L or less. That is, it is preferable to directly prepare an aqueous emulsion of the silyl ester-based polymer by emulsion polymerization of the polymerizable monomer used for forming the silyl ester-based polymer. Examples of the emulsion polymerization method include a seed polymerization method, a mini-emulsion polymerization method, and a precipitation polymerization method in addition to a normal emulsion polymerization method. In the emulsion polymerization, the above-mentioned reactive surfactant may be used as some of the polymerizable monomers.

In the emulsion polymerization method, for example, a surfactant (also referred to as an emulsifier) is used. The surfactant may be a reactive surfactant or a non-reactive surfactant. The surfactant may be the reactive surfactant from the viewpoint of further improving the long-term antifouling property and crack resistance in the antifouling coating film. The details of the reactive surfactant are as described above, and the description thereof is omitted here. The non-reactive surfactant (also referred to as a non-reactive emulsifier) refers to a surfactant having no polymerizable unsaturated bond such as an ethylenically unsaturated bond in the molecule.

Examples of the non-reactive surfactant include anionic surfactants, nonionic surfactants, cationic surfactants, and amphoteric surfactants. The non-reactive surfactant may have the poly (oxyalkylene) structure. One or two or more of the non-reactive surfactants may be used. For example, the anionic surfactant and the nonionic surfactant may be used in combination.

Examples of the non-reactive anionic surfactant include fatty acid salts such as a sodium lauryl sulfate, higher alcohol sulfuric acid ester salts, alkylbenzene sulfonates such as a sodium dodecylbenzene sulfonate, polyoxyalkylene alkyl ether sulfates such as a polyoxyethylene alkyl ether sulfate, polyoxyethylene polycyclic phenyl ether sulfates, polyoxynonylphenyl ether sulfonates, polyoxyethylene-polyoxypropylene glycol ether sulfates, and dioctyl sulfosuccinates. Examples of the non-reactive nonionic surfactant include polyoxyalkylene alkyl ethers such as a polyoxyethylene alkyl ether and a polyoxyalkylene decyl ether, polyoxyalkylene alkyl aryl ethers such as a polyoxyethylene nonylphenyl ether, sorbitan fatty acid esters, polyoxyethylene fatty acid esters, and polyoxyethylene-polyoxypropylene block polymers. Examples of the non-reactive cationic surfactant include alkylamine salts and quaternary ammonium salts.

In one embodiment, the used amount of the surfactant is preferably 0.1 parts by mass or more, more preferably 0.5 parts by mass or more, still more preferably 1 part by mass or more, further more preferably 1.5 parts by mass or more, and particularly preferably 2 parts by mass or more, and is preferably 10 parts by mass or less, more preferably 9 parts by mass or less, and still more preferably 8 parts by mass or less, and is, for example, 0.1 to 10 parts by mass with respect to 100 parts by mass of the polymerizable monomer other than the reactive surfactant, used for forming the silyl ester-based polymer. The surfactant may be the reactive surfactant, the non-reactive surfactant, or a combination thereof. The above-described molar ratio ((a) (b)) of the triorganosilyl group (a) to the oxyalkylene unit (b) may be adjusted using the surfactant having the poly (oxyalkylene) structure.

At the time of polymerization of the polymerizable monomer, a polymerization initiator may be used. As the polymerization initiator, various radical polymerization initiators can be used. One or two or more of the radical polymerization initiators may be used. These radical polymerization initiators may be added into a reaction system only at the start of a reaction in a polymerization reaction, or may be added into the reaction system both at the start of the reaction and during the reaction. Examples of the radical polymerization initiator include, specifically, azo-based compounds such as 2,2′-azobis (isobutyronitrile), 2,2′-azobis (2-methylbutyronitrile), 2,2′-azobis (2,4-dimethylvaleronitrile), and 4,4′-azobis-4-cyanovaleric acid; organic peroxides such as t-butyl peroxyoctoate, t-butyl peroxybenzoate and di-t-butyl peroxide; persulfates such as an ammonium persulfate, a potassium persulfate, and a sodium persulfate; and hydrogen peroxide. The used amount of the polymerization initiator is, for example, 0.1 to 20 parts by mass with respect to 100 parts by mass of the total of the polymerizable monomers used for forming the silyl ester-based polymer.

At the time of polymerization of the polymerizable monomer, a chain transfer agent may be used. One or two or more of the chain transfer agents may be used. Examples of the chain transfer agent include α-methylstyrene dimer, thiophenol, diterpene, terpinolene, and γ-terpinene; mercaptans such as thioglycolic acid, 2-ethylhexyl thioglycolic acid, mercaptopropionic acid, 2-ethylhexyl mercaptopropionic acid, tert-dodecyl mercaptan, and n-dodecyl mercaptan; halides such as carbon tetrachloride, methylene chloride, bromoform, and bromotrichloroethane; and secondary alcohols such as isopropanol and glycerin. The used amount of the chain transfer agent is, for example, 0.1 to 5 parts by mass with respect to 100 parts by mass of the total of the polymerizable monomers used for forming the silyl ester-based polymer.

At the time of polymerization of the polymerizable monomer, a solvent may be used. Examples of the solvent include water and an organic solvent. Examples of the organic solvent include aromatic hydrocarbon-based solvents such as toluene, o-xylene, m-xylene, p-xylene, ethylbenzene, and mesitylene; alcohol-based solvents such as ethanol, propanol, isopropyl alcohol, butanol and isobutanol; ether-based solvents such as propylene glycol monomethyl ether and dipropylene glycol monomethyl ether; ketone-based solvents such as methyl ethyl ketone, methyl isobutyl ketone, methyl amyl ketone, and cyclohexanone; and ester-based solvents such as ethyl acetate, butyl acetate and propylene glycol monomethyl ether acetate.

In the production of the composition of the present disclosure, it is preferable to use an aqueous dispersion of the silyl ester-based polymer, it is more preferable to use an aqueous emulsion of the silyl ester-based polymer, and it is still more preferable to use an emulsion polymer of the silyl ester-based polymer, from the viewpoint of easily adjusting the VOC content in the composition to 100 g/L or less and from the viewpoint of physical properties of the coating film. The content ratio of the solid content in the aqueous dispersion of the silyl ester-based polymer is preferably 30 mass % or more and more preferably 40 mass % or more, and is preferably 70 mass % or less and more preferably 60 mass % or less, and is, for example, 30 to 70 mass % from the viewpoint of stability of the dispersion.

The aqueous dispersion of the silyl ester-based polymer is a dispersion in which the silyl ester-based polymer is dispersed in a dispersion medium containing water (the dispersion medium is hereinafter also referred to as “aqueous medium”). The aqueous medium is not particularly limited as long as it contains water, and the content ratio of water in the aqueous medium is preferably 70 to 100 mass % and more preferably 80 to 100 mass %.

The aqueous medium may contain a medium other than water, examples of such a medium include acetone, methyl alcohol, ethyl alcohol, n-propyl alcohol, isopropyl alcohol, n-butyl alcohol, isobutyl alcohol, 2-methoxyethanol, 2-ethoxyethanol, 2-butoxyethanol, 1-methoxy-2-propanol, 1-ethoxy-2-propanol, diacetone alcohol, dioxane, ethylene glycol, ethylene glycol dimethyl ether, ethylene glycol diethyl ether, ethylene glycol monopropyl ether, ethylene glycol monobutyl ether, and ethylene glycol monohexyl ether. One or two or more of these can be used.

As described above, the aqueous emulsion of the silyl ester-based polymer can be prepared by emulsion polymerization of the polymerizable monomer used for forming the silyl ester-based polymer. Specifically, the aqueous emulsion of the silyl ester-based polymer can be prepared by emulsifying and polymerizing the polymerizable monomer in water. The polymerization temperature is preferably 50 to 90° C. and more preferably 60 to 85° C.

The aqueous emulsion of the silyl ester-based polymer can also be prepared by emulsifying (for example, mechanically emulsifying) an organic solvent-based solution containing the silyl ester-based polymer. Examples of the emulsification method in the case of emulsifying the above solution include conventionally known methods such as a natural emulsification method, an interfacial chemical emulsification method, an electric emulsification method, a capillary emulsification method, a phase inversion emulsification method, a mechanical emulsification method, and an ultrasonic emulsification method, and a surfactant may be used. Note that when this method is used, the VOC content may not be sufficiently reduced. Thus, it is preferable to prepare the aqueous emulsion by the emulsion polymerization from the viewpoint of setting the VOC content to 100 g/L or less.

A Z-average particle diameter of the silyl ester-based polymer particles contained in the aqueous emulsion of the silyl ester-based polymer is preferably 500 nm or less, more preferably 400 nm or less, still more preferably 300 nm or less, further more preferably 250 nm or less, and particularly preferably 200 nm or less, and is preferably 50 nm or more, more preferably 80 nm or more, and still more preferably 100 nm or more, and is, for example, 50 to 500 nm. The aqueous emulsion containing the silyl ester-based polymer particles having the Z-average particle diameter of an upper limit value or less and a lower limit value or more tends to be excellent in particle stability and water resistance in a well-balanced manner. The Z-average particle diameter is measured at 25° C. by a dynamic light scattering method using a particle diameter measuring apparatus (for example, Zetasizer Nano-ZS manufactured by Malvern Panalytical).

### <Antifouling Agent>

The composition of the present disclosure preferably contains an antifouling agent.

Examples of the antifouling agent include inorganic antifouling agents and organic antifouling agents.

Examples of the inorganic antifouling agent include copper or a copper compound (provided that pyrithione-based compounds are excluded.) such as cuprous oxide, metal copper powder, and copper (I) thiocyanate (copper rhodanide), preferably cuprous oxide and copper (I) thiocyanate (copper rhodanide), and more preferably cuprous oxide. The composition of the present disclosure tends to be excellent in storage stability even when it contains cuprous oxide. The median diameter (D50) of cuprous oxide is preferably 1 to 30 μm. Cuprous oxide may be subjected to a surface treatment. As the surface treatment of cuprous oxide, a treatment with a surface treatment agent such as glycerin, stearic acid, lauric acid, sucrose, lecithin, or mineral oil is preferable from the viewpoint of the antifouling property of the coating film and long-term stability during storage of the composition.

The median diameter (D50) is measured by a laser diffraction scattering method, and SALD-2200 (manufactured by SHIMADZU CORPORATION) can be used as a measuring apparatus. Details of a measuring method are as follows. A 0.2 mass % aqueous solution of sodium hexametaphosphate (HMPNa) and several drops of a neutral detergent (manufactured by Kao Corporation, product name: Kyukyutto) are added to a sample disperser, and ultrasonic waves are activated to circulate the solution. Thereafter, about 100 mg of cuprous oxide is taken in a mortar, and several drops of the neutral detergent are added, and lightly dispersed in order to loosen secondary aggregation of cuprous oxide. Water is added to the sample dispersed in the mortar so as not to form bubbles, and the mixture is poured into the sample disperser. After circulation and dispersion treatment for 10 minutes in the sample disperser, volume-based particle size distribution measurement is performed using the measuring apparatus. Using “2.70-0.20i” as a refractive index at the time of particle size distribution calculation, the median diameter (D50) is obtained from the particle size distribution.

Examples of the organic antifouling agent include metal pyrithione (pyrithione-based compound) such as copper pyrithione and zinc pyrithione; tetraalkylthiuram disulfide such as tetramethylthiuram disulfide; carbamate-based compounds such as zinc dimethyl dithiocarbamate, zinc ethylene bisdithiocarbamate, and bis dimethyldithiocarbamoyl zinc ethylene bisdithiocarbamate; maleimide-based compounds such as 2,4,6-triphenylmaleimide, 2,3-dichloro-N-(2′,6′-diethylphenyl) maleimide, and 2,3-dichloro-N-(2′-ethyl-6′-methylphenyl) maleimide; 2,4,5,6-tetrachloroisophthalonitrile, N,N-dimethyldichlorophenylurea, 4,5-dichloro-2-n-octyl-4-isothiazoline-3-one (DCOIT), 2-methylthio-4-tert-butylamino-6-cyclopropyl-S-triazine, chloromethyl-n-octyl disulfide, N′,N′-dimethyl-N-phenyl-(N-fluorodichloromethylthio) sulfamide, and N′,N′-dimethyl-N-tolyl-(N-fluorodichloromethylthio) sulfamide; amine-organic borane complexes such as pyridine triphenylborane and 4-isopropylpyridine diphenylmethylborane; and (+/−)-4-[1-(2,3-dimethylphenyl) ethyl]-1H-imidazole (medetomidine).

Among these organic antifouling agents, copper pyrithione, zinc pyrithione, zinc ethylene bisdithiocarbamate, 2-methylthio-4-tert-butylamino-6-cyclopropyl-S-triazine, 4,5-dichloro-2-n-octyl-4-isothiazoline-3-one (DCOIT) and (+/−)-4-[1-(2,3-dimethylphenyl) ethyl]-1H-imidazole (medetomidine) are preferable, and copper pyrithione, 4,5-dichloro-2-n-octyl-4-isothiazoline-3-one (DCOIT), and (+/−)-4-[1-(2,3-dimethylphenyl) ethyl]-1H-imidazole (medetomidine) are more preferable.

One or two or more of the antifouling agents can be used.

When the composition of the present disclosure contains the antifouling agent, the content ratio of the antifouling agent is preferably 0.01 mass % or more, more preferably 0.1 mass % or more, and still more preferably 1 mass % or more, and may be 5 mass % or more, 10 mass % or more, 15 mass % or more, 20 mass % or more, 25 mass % or more, and 30 mass % or more, and is preferably 80 mass % or less, more preferably 75 mass % or less, and still more preferably 70 mass % or less, and is, for example, 0.01 to 80 mass % in 100 mass % of the solid content of the composition of the present disclosure.

### <Other Components>

The composition of the present disclosure may contain, if necessary, as other components, at least one selected from a binder component other than the silyl ester-based polymer, a pigment, and an additive.

The composition of the present disclosure may further contain a binder component other than the silyl ester-based polymer from the viewpoint of further improving physical properties of the antifouling coating film such as the antifouling property, crack resistance and strength. Examples of the binder component include a (meth) acrylic polymer, a vinyl-based polymer (for example, polyvinyl alcohol), polyester, a terpene phenol resin, a petroleum resin, and a ketone resin. One or two or more of the binder components can be used.

When the composition of the present disclosure contains a binder component other than the silyl ester-based polymer, the content of the binder component is preferably 50 parts by mass or less, more preferably 30 parts by mass or less, and still more preferably 10 parts by mass or less with respect to 100 parts by mass of the silyl ester-based polymer.

Examples of the pigment include extender pigments and coloring pigments. Examples of the additive include surfactants, pigment dispersants, rosin-based compounds, defoamers, thickeners, anti-settling agents, and coalescents. One or two or more of the pigments can be used. One or two or more of the additives can be used.

Examples of the extender pigment include zinc oxide, talc, silica, mica, clay, potassium feldspar, calcium carbonate, kaolin, alumina white, white carbon, aluminum hydroxide, magnesium carbonate, barium carbonate, barium sulfate, and zinc sulfide. When the composition of the present disclosure contains the extender pigment, the content ratio of the extender pigment is preferably 0.1 mass % or more, more preferably 1 mass % or more, and still more preferably 5 mass % or more, and is preferably 90 mass % or less, more preferably 70 mass % or less, and still more preferably 50 mass % or less, and is, for example, 0.1 to 90 mass % in 100 mass % of the solid content of the composition of the present disclosure.

Examples of the coloring pigment include inorganic pigments and organic pigments. Examples of the inorganic pigment include carbon black, red iron oxide, titanium white (titanium oxide), and yellow iron oxide. Examples of the organic pigment include naphthol red and phthalocyanine blue. When the composition of the present disclosure contains the coloring pigment, the content ratio of the coloring pigment is preferably 0.01 mass % or more, more preferably 0.1 mass % or more, and still more preferably 0.5 mass % or more, and is preferably 50 mass % or less, more preferably 30 mass % or less, and still more preferably 10 mass % or less, and is, for example, 0.01 to 50 mass % in 100 mass % of the solid content of the composition of the present disclosure.

Details of the surfactant are as described above, and description thereof in this section is omitted. The molar ratio ((a):(b)) of the triorganosilyl group (a) to the oxyalkylene unit (b) in the composition of the present disclosure may be adjusted to the above-described range using the surfactant having the poly (oxyalkylene) structure.

The pigment dispersant is preferably a dispersant capable of uniformly wet-dispersing the pigment in the coating composition to prepare a stable dispersion. The pigment dispersant may have the poly (oxyalkylene) structure. When the composition of the present disclosure contains the pigment dispersant, the content ratio of the pigment dispersant is preferably 0.01 mass % or more, more preferably 0.1 mass % or more, and still more preferably 0.5 mass % or more, and is preferably 5 mass % or less, and is, for example, 0.01 to 5 mass % in 100 mass % of the solid content of the composition of the present disclosure.

The rosin-based compound is at least one selected from rosin and derivatives thereof. The rosin-based compound contributes to, for example, adjustment of the consumption rate of the coating film and improvement of the long-term antifouling property. Examples of the rosin-based compound include rosin such as gum rosin, wood rosin, and tall oil rosin; rosin derivatives such as hydrogenated rosin, disproportionated rosin, polymerized rosin, and rosin metal salts. Examples of the metal salt include alkali metal salts such as a sodium salt and a potassium salt, zinc salts, copper salts, aluminum salts, magnesium salts, calcium salts, and barium salts. Besides these, hydrogenated rosin metal salts, disproportionated rosin metal salts and polymerized rosin metal salts are also included.

As the rosin-based compound, at least one selected from rosin-based resin acids, which are components contained in rosin, and derivatives thereof may be used. Examples of the rosin-based resin acid and derivatives thereof include abietic acid, neoabietic acid, dehydroabietic acid, secodehydroabietic acid, dihydroabietic acid, tetrahydroabietic acid, pimaric acid, isopimaric acid, levopimaric acid, palustric acid, and sandaracopimaric acid.

When the composition of the present disclosure contains the rosin-based compound, the content ratio of the rosin-based compound is preferably 0.1 mass % or more, more preferably 0.5 mass % or more, and still more preferably 1 mass % or more, and is preferably 15 mass % or less, more preferably 10 mass % or less, and still more preferably 5 mass % or less, and is, for example, 0.1 to 15 mass % in 100 mass % of the solid content of the composition of the present disclosure.

The defoamer is preferably a material capable of suppressing generation of bubbles during the production and coating of the coating composition or a material capable of breaking bubbles generated in the coating composition. By using the defoamer, generation of air bubble marks or pinholes in the coating film can be suppressed, for example, and thus the film formability, antifouling property, and crack resistance of the coating film can be further improved. Examples of the defoamer include silicone-based defoamers, polymer-based (non-silicone-based) defoamers, and mineral oil-based defoamers. When the composition of the present disclosure contains the defoamer, the content ratio of the defoamer is preferably 0.01 mass % or more and more preferably 0.1 mass % or more, and is preferably 2 mass % or less and more preferably 1.5 mass % or less, and is, for example, 0.01 to 2 mass % in 100 mass % of the solid content of the composition of the present disclosure.

As the thickener, for example, a commercially available product generally sold as a thickener can be used. The commercially available product is not particularly limited, and examples thereof include thickeners such as an alkali thickening type, a nonionic associative type, an acrylic type, a urethane type, a water-soluble polymer type, a polyamide type, and hydroxyethyl cellulose. When the composition of the present disclosure contains the thickener, the content ratio of the thickener is preferably 0.01 mass % or more and more preferably 0.1 mass % or more, and is preferably 10 mass % or less, more preferably 5 mass % or less, and still more preferably 1 mass % or less, and is for example, 0.01 to 10 mass % in 100 mass % of the solid content of the composition of the present disclosure.

As the anti-settling agent, materials capable of suppressing settling of the pigment in the coating composition and improving storage stability of the coating composition are preferable. Examples of the anti-settling agent include organic thixotropic agents such as hydrogenated castor oil-based thixotropic agents, amide wax-based thixotropic agents, and polyethylene oxide-based thixotropic agents; and inorganic thixotropic agents such as clay minerals (examples: bentonite, smectite and hectorite) and synthetic fine silica. When the composition of the present disclosure contains the anti-settling agent, the content ratio of the anti-settling agent is preferably 0.01 to 5 mass % in 100 mass % of the solid content of the composition of the present disclosure.

Examples of the coalescent include alcohols, glycol ethers, and esters, and specific examples thereof include alcohols such as alcohols having 1 to 3 carbon atoms such as isopropyl alcohol and the like, 2,2,4-trimethylpentanediol and benzyl alcohol; glycol ethers such as ethylene glycol monobutyl ether, ethylene glycol diethyl ether, diethylene glycol monobutyl ether, diethylene glycol diethyl ether, propylene glycol diethyl ether, dipropylene glycol diethyl ether, dipropylene glycol n-butyl ether, ethylene glycol monobenzyl ether and ethylene glycol monophenyl ether; and esters such as 2,2,4-trimethyl-1,3-pentanediol monoisobutyrate. When the composition of the present disclosure contains the coalescent, the content ratio of the coalescent is preferably 0.1 mass % or more and more preferably 0.5 mass % or more, and is preferably 15 mass % or less and more preferably 5 mass % or less, and is, for example, 0.1 to 15 mass % in 100 mass % of the total amount of the composition of the present disclosure.

### <Water>

The composition of the present disclosure is a waterborne antifouling coating composition. In the present disclosure, the “waterborne” composition refers to a composition containing water. The content ratio of water in the composition of the present disclosure is preferably 10 mass % or more and more preferably 15 mass % or more, and is preferably 50 mass % or less and more preferably 45 mass % or less, and is, for example, 10 to 50 mass %.

The content ratio of the solid content in the composition of the present disclosure is preferably 50 mass % or more and more preferably 55 mass % or more, and is preferably 90 mass % or less and more preferably 85 mass % or less, and is, for example, 50 to 90 mass % from the viewpoint of forming a composition excellent in coating workability.

### <Method for Producing Antifouling Coating Composition>

The composition of the present disclosure can be produced by appropriately using a known method, and for example, can be produced by adding the silyl ester-based polymer and, if necessary, the antifouling agent and/or other components to a stirring container at once or in any order, mixing the components with a known stirring and mixing means, and dispersing or dissolving the components in water. In the production of the composition of the present disclosure, it is preferable to use the aqueous dispersion of the silyl ester-based polymer from the viewpoint of workability in the production of a coating material.

Examples of the stirring and mixing means include means using a paint shaker, a high speed disperser, a sand grinding mill, a basket mill, a ball mill, a three-roll mill, a ross mixer, or a planetary mixer.

The composition of the present disclosure is a waterborne coating material, thus having extremely little adverse effects on the environment and the human body and being excellent in storage stability. The composition of the present disclosure can form the antifouling coating film excellent in the antifouling property, crack resistance, and stability of the coating film consumption degree while being a waterborne composition. Specifically, the composition of the present disclosure can form the coating film excellent in crack resistance and capable of suppressing adhesion of aquatic organisms over a long period of time on a surface of a substrate such as a member constituting a ship. The improvement of crack resistance suppresses an increase in surface roughness and an increase in water stream resistance of the coating film due to generation of cracks, and also contributes to a reduction in fuel consumption in the case of a ship, for example. In addition, cracks and peeling of the coating film are less likely to occur even when the composition of the present disclosure is applied repeatedly, and thus the composition is also suitable for repair coating.

### [Use Application of Antifouling Coating Composition]

The antifouling coating film of the present disclosure is made of the composition of the present disclosure. An antifouling substrate of the present disclosure includes a substrate and the antifouling coating film of the present disclosure provided on the substrate.

A method for producing the antifouling substrate of the present disclosure includes a step of obtaining an applied body or an impregnated body by applying or impregnating the composition of the present disclosure to a substrate (object to be coated), and a step of drying the applied body or the impregnated body.

For the application of the composition, for example, known methods such as air spray, airless spray, brush coating, and roller coating can be used.

The composition of the present disclosure applied or impregnated by the above-described method is dried, for example, by being left at 5 to 40° C. for preferably about 1 day to 10 days and more preferably about 1 day to 7 days. Thus, the antifouling coating film can be formed. The drying of the composition may be performed while blowing air under heating.

Alternatively, the antifouling substrate of the present disclosure can also be produced by forming the antifouling coating film from the composition of the present disclosure on a surface of a temporary substrate, peeling the antifouling coating film from the temporary substrate, and attaching the antifouling coating film to the substrate to be antifouling. At this time, the antifouling coating film may be attached onto the substrate via an adhesive layer.

The surface of the substrate may be subjected to a primer treatment. A layer made of a resin-based coating material may be provided on the surface of the substrate. Examples of the resin-based coating material include epoxy resin-based coating materials, vinyl resin-based coating materials, acrylic resin-based coating materials, and urethane resin-based coating materials. In this case, the surface of the substrate on which the antifouling coating film is provided means a surface after the primer treatment or a surface of a layer made of the resin-based coating material.

The substrate is not particularly limited, and the composition of the present disclosure is preferably used for, for example, causing the substrate to be antifouling for a long period of time in a wide range of industrial fields such as ships, fishery, and underwater structures. Examples of the substrate include members (for example, a hull outer plate such as a steel plate) constituting a ship, underwater structures, fishery materials, water supply/drain pipes for, for example, seawater in factories and thermal and nuclear power plants, diver suits, swimming goggles, oxygen cylinders, swimsuits, and torpedoes. Examples of the ship include large steel ships such as container ships and tankers, fishing boats, FRP ships, wooden ships, and yachts, and any of these new ships or repair ships may be included. Examples of the underwater structure include oil pipelines, water conduit pipes, circulating water pipes, water supply/drain ports in factories and thermal and nuclear power plants, submarine cables, sea water utilization equipment (for example, sea water pumps), and various underwater civil engineering structures in megafloats, coastal roads, submarine tunnels, harbor facilities, and canals and water channels. Examples of the fishing material include ropes, fishing nets, fishing gears, floats, and buoys. Among them, the members constituting a ship, the underwater structures, the fishing materials, and the water supply/drain pipes are preferable, the members constituting a ship and the underwater structures are more preferable, and the members constituting a ship are particularly preferable.

When the antifouling substrate of the present disclosure is produced, the composition of the present disclosure may be directly applied to the surface of the substrate in a case where the substrate is the fishing net or the steel plate, the composition of the present disclosure may be impregnated on the surface of the substrate in a case where the substrate is the fishing net, and the composition of the present disclosure may be applied to a surface of an underlaying layer after the underlaying layer is formed by previously applying an underlaying material such as a rust inhibitor or a primer to the surface of the substrate in a case where the substrate is the steel plate. In addition, the antifouling coating film of the present disclosure may be further formed for the purpose of repair on a surface of a substrate on which the antifouling coating film of the present disclosure or the conventional antifouling coating film is formed as in the steel plate having a deteriorated antifouling coating film.

The thickness of the antifouling coating film of the present disclosure is, for example, about 30 to 1,000 μm, may be 50 μm or more, or 100 μm or more, and may be 800 μm or less, 600 μm or less, or 400 μm or less. When the antifouling coating film is formed, examples of a method include a method of applying the composition once to a plurality of times where a thickness of the antifouling coating film formed by one coating is preferably 10 to 300 μm and more preferably 30 to 200 μm.

The ship having the antifouling coating film of the present disclosure can suppress a decrease in a ship speed and an increase in fuel consumption due to the ability to suppress the adhesion of the aquatic organisms. The underwater structure having the antifouling coating film of the present disclosure can maintain the function of the underwater structure for a long period of time due to the ability to suppress the adhesion of the aquatic organisms for a long period of time. The fish net having the antifouling coating film of the present disclosure has a low risk of environmental pollution and can suppress clogging of the mesh due to the ability to suppress the adhesion of the aquatic organisms. The water supply/drain pipe having the antifouling coating film of the present disclosure on its inner surface can suppress clogging of the water supply/drain pipe and a decrease in flow rate due to the ability to suppress the adhesion and propagation of the aquatic organisms.

### Aspects of Present Disclosure

The present disclosure relates to, for example, the following [1] to [14].

[1] An antifouling coating composition containing a silyl ester-based polymer and water, wherein the silyl ester-based polymer has a triorganosilyl group, the antifouling coating composition has a volatile organic compound (VOC) content of 100 g/L or less, and an oxyalkylene unit is present in the antifouling coating composition, and a molar ratio ((a):(b)) of a triorganosilyl group (a) to an oxyalkylene unit (b) measured by ¹³C-NMR with respect to the antifouling coating composition is 40.0:60.0 to 48.5:51.5.

[2] The antifouling coating composition according to the above-described [1], wherein the oxyalkylene unit constitutes a poly (oxyalkylene) structure.

[3] The antifouling coating composition according to the above-described [1] or [2], wherein the oxyalkylene unit is at least one selected from an oxyethylene unit and an oxypropylene unit.

[4] The antifouling coating composition according to any one of the above-described [1] to [3], wherein the silyl ester-based polymer includes a structural unit (a-1) derived from a polymerizable monomer (a1) represented by the following Formula (a1):

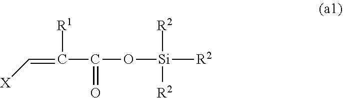

[In Formula (a1), R¹ is a hydrogen atom or a methyl group, each R² is independently a monovalent organic group having 1 to 20 carbon atoms optionally having a hetero atom, provided that an atom bonded to a silicon atom (Si) in Formula (a1) in the organic group is a carbon atom, X is a hydrogen atom or a group represented by R³—O—C(═O)—, R³ is a hydrogen atom, a monovalent organic group having 1 to 20 carbon atoms optionally having a hetero atom, or a silyl group represented by (R⁴)3Si—, and each R⁴ is independently a monovalent organic group having 1 to 20 carbon atoms optionally having a hetero atom, provided that an atom bonded to the silicon atom (Si) contained in the silyl group in the organic group is a carbon atom.]

[5] The antifouling coating composition according to the above-described [4], wherein the silyl ester-based polymer has a content ratio of the structural unit (a-1) of 30 mass % or more.

[6] The antifouling coating composition according to any one of the above-described [1] to [5], wherein the triorganosilyl group is a trialkylsilyl group.

[7] The antifouling coating composition according to the above-described [6], wherein the trialkylsilyl group is a triisopropylsilyl group.

[8] The antifouling coating composition according to any one of the above-described [1] to [7], wherein a content ratio of the silyl ester-based polymer is 5 to 30 mass % in 100 mass % of the solid content of the antifouling coating composition.

[9] The antifouling coating composition according to any one of the above-described [1] to [8], further containing cuprous oxide.

[10] The antifouling coating composition according to any one of the above-described [1] to [9], further containing an organic antifouling agent.

[11] The antifouling coating composition according to any one of the above-described [1] to [10], wherein a content ratio of water in the antifouling coating composition is 10 to 50 mass %.

[12] An antifouling coating film made of the antifouling coating composition according to any one of the above-described [1] to [11].

[13] An antifouling substrate including a substrate and the antifouling coating film according to the above-described [12] provided on the substrate.

[14] A method for producing an antifouling substrate, including a step of obtaining an applied body or an impregnated body by applying or impregnating the antifouling coating composition according to any one of the above-described [1] to [11] to a substrate, and a step of drying the applied body or the impregnated body.

### EXAMPLES

Hereinafter, the antifouling coating composition of the present disclosure will be described more specifically based on Examples and Comparative Examples, but the antifouling coating composition of the present disclosure is not limited to the following Examples at all. In the following Examples and Comparative Examples, “part(s)” represents “part(s) by mass”.

### [Solid Content Concentration]

The solid content of the composition and each component mean a heating residue when each of the composition and each component is dried in a thermostatic chamber at 108° C. for 3 hours. Specifically, the heating residue is a residue of a sample obtained by weighing 1.0 g of the sample in a flat bottom dish, uniformly spreading the sample using a wire having a known mass, and drying the sample in the thermostatic chamber under the conditions of 1 atm and 108° C. for 3 hours. From the amount of the heating residue, content ratios (solid content concentration) (mass %) of the solid contents of the composition and each component were calculated.

### Production Example 1

A reaction operation was performed under a nitrogen flow.

A flask equipped with a stirrer and a nitrogen introducing tube was charged with 418.5 parts of deionized water, 450 parts of triisopropylsilyl methacrylate, 270 parts of methyl methacrylate, 180 parts of butyl acrylate, 13.5 parts of polyoxyethylene styrenated propenyl phenyl ether sulfuric acid ester ammonium (reactive surfactant), and 45 parts of polyoxyethylene styrenated propenyl phenyl ether (reactive surfactant), and the mixture was stirred well to prepare a pre-emulsion.

A flask equipped with 2 dropping funnels, a stirrer, a nitrogen introducing tube, a thermometer, and a reflux condenser was charged with 135 parts of the pre-emulsion and 315 parts of deionized water. The flask was heated until an internal temperature reached 78° C., 45 parts of a 2% aqueous ammonium persulfate solution was added, and the internal temperature of 78 t 2° C. was maintained for 40 minutes. Next, while the same temperature was maintained, 1215 parts of the pre-emulsion was added dropwise over 2.5 hours from the dropping funnel, and 270 parts of a 0.5% aqueous ammonium persulfate solution was added dropwise over 3 hours from the dropping funnel, and the same temperature was maintained for 2 hours after completion of the dropwise addition. Thereafter, the contents of the flask were cooled to room temperature, and then 3.6 parts of 28% ammonia water and 91.4 parts of deionized water were added, and the contents of the flask were filtered through a 120 mesh net to obtain an emulsion polymer 1. The obtained emulsion polymer 1 had a solid content concentration of 45 mass %. The Z-average particle diameter in the emulsion polymer 1 was in a range of 140 nm to 180 nm.

### Production Examples 2 to 11

Emulsion polymers 2 to 11 were obtained in the same manner as in Production Example 1 except that a type and a used amount (used amount with respect to 100 parts of the polymerizable monomer other than the reactive surfactant) of the surfactant were changed as shown in Table 1. Each numerical value described for, for example, the polymerizable monomer in Table 1 represents part(s) by mass.

The surfactants used in the above Production Examples are described below.

AQUALON AR-10 (reactive anionic surfactant, polyoxyethylene styrenated propenylphenyl ether sulfuric acid ester ammonium, manufactured by DKS Co. Ltd.)

AQUALON AR-20 (reactive anionic surfactant, polyoxyethylene styrenated propenylphenyl ether sulfuric acid ester ammonium, manufactured by DKS Co. Ltd.)

AQUALON AN-10 (reactive nonionic surfactant, polyoxyethylene styrenated propenylphenyl ether, manufactured by DKS Co. Ltd.)

AQUALON AN-20 (reactive nonionic surfactant, polyoxyethylene styrenated propenylphenyl ether, manufactured by DKS Co. Ltd.)

HITENOL LA-16 (non-reactive anionic surfactant, polyoxyethylene lauryl ether ammonium sulfate, manufactured by DKS Co. Ltd.)

MONOGEN Y-100 (non-reactive anionic surfactant, sodium lauryl sulfate, manufactured by DKS Co. Ltd.)

NEOGEN S-20F (non-reactive anionic surfactant, sodium linear alkylbenzene sulfonate, manufactured by DKS Co. Ltd.)

NOIGEN XL-400D (non-reactive nonionic surfactant, polyoxyalkylene branched decyl ether, manufactured by DKS Co. Ltd.)

### Production Example 12

Each reaction was performed under normal pressure and a nitrogen atmosphere. A reaction vessel equipped with a stirrer, a reflux condenser, a thermometer, a nitrogen introducing tube, and a dropping funnel was charged with 428.6 parts of xylene and 50 parts of triisopropylsilyl methacrylate (TIPSMA), and the mixture was heated until the liquid temperature in the reaction vessel reached 85° C. while being stirred with the stirrer. A mixture composed of 450 parts of TIPSMA, 200 parts of 2-methoxyethyl methacrylate, 240 parts of methyl methacrylate, 60 parts of butyl acrylate, and 20 parts of 2,2′-azobis (isobutyronitrile) (AIBN) were added dropwise into the reaction vessel over 3 hours using the dropping funnel while maintaining the liquid temperature in the reaction vessel at 85±5° C.

After completion of the dropwise addition, the reaction liquid in the reaction vessel was stirred at 85° C. for 1 hour and at 85° C. to 95° C. for 1 hour. Thereafter, 1 part of AIBN was added to the reaction liquid 4 times every 30 minutes while maintaining the temperature at 95° C., and the liquid temperature was raised to 105° C. to complete the polymerization reaction to obtain a polymer solution.

A polyethylene container was charged with 2,400 parts of the polymer solution, 185 parts of NOIGEN XL-400D (manufactured by DKS Co. Ltd., solid content concentration: 65 mass %) and 1,300 parts of deionized water, and a dispersion treatment was performed at 5,000 rpm for 20 minutes. Next, the obtained mixture was subjected to a 5 pass dispersion treatment at a pressure of 150 MPa using a high pressure homogenizer (Star Burst HJP-25005, manufactured by Sugino Machine Limited). The obtained dispersion was diluted by adding deionized water until the solid content concentration reached 45 mass %. In this way, emulsion 1 was obtained. The Z-average particle diameter of the emulsion 1 was 350 nm.

TABLE 1

| | Production | Production | Production | Production | Production |
|---|---|---|---|---|---|
| | Example 2 | Example 3 | Example 4 | Example 5 | Example 6 |
| Emulsion Polymer | 2 | 3 | 4 | 5 | 6 |
| Polymerizable Monomer | | | | | |
| Triisopropylsilyl methacrylate | 450 | 450 | 450 | 450 | 450 |
| Methyl methacrylate | 270 | 270 | 270 | 270 | 270 |
| Butyl acrylate | 180 | 180 | 180 | 180 | 180 |
| AQUALON AR-10 | | | 13.5 | | |
| AQUALON AR-20 | 13.5 | | | 13.5 | |
| AQUALON AN-10 | | | 45 | | |
| AQUALON AN-20 | 27 | | | 18 | |
| Non-reactive surfactant | | | | | |
| HITENOL LA-16 | | 72 | | | |
| MONOGEN Y-100 | | | | | 54 |
| NEOGEN S-20F | | | | | |
| Total amount (parts by mass) of | 4.5 | 8 | 6.5 | 3.5 | 6 |
| surfactant with respect to 100 parts | | | | | |
| by mass of polymerizable monomer | | | | | |
| other than reactive surfactant | | | | | |

| | Production | Production | Production | Production | Production |
|---|---|---|---|---|---|
| | Example 7 | Example 8 | Example 9 | Example 10 | Example 11 |
| Emulsion Polymer | 7 | 8 | 9 | 10 | 11 |
| Polymerizable Monomer | | | | | |
| Triisopropylsilyl methacrylate | 450 | 450 | 450 | 450 | 450 |
| Methyl methacrylate | 270 | 270 | 270 | 270 | 270 |
| Butyl acrylate | 180 | 180 | 180 | 180 | 180 |
| AQUALON AR-10 | | | | 13.5 | 13.5 |
| AQUALON AR-20 | | | | | |
| AQUALON AN-10 | | | | 18 | 36 |
| AQUALON AN-20 | | | | | |
| Non-reactive surfactant | | | | | |
| HITENOL LA-16 | | | 54 | | |
| MONOGEN Y-100 | 72 | | | | |
| NEOGEN S-20F | | 72 | | | |
| Total amount (parts by mass) of | 8 | 8 | 6 | 3.5 | 5.5 |
| surfactant with respect to 100 parts | | | | | |
| by mass of polymerizable monomer | | | | | |
| other than reactive surfactant | | | | | |

### Preparation of Antifouling Coating Composition

### Example 1

The antifouling coating composition was prepared as follows.

In a polyethylene container, 14.5 parts of deionized water and 1.0 part of DISPERBYK-194N (wetting and dispersing agent, solution of copolymer having a pigment affinity group, manufactured by BYK Japan KK) were mixed using a paint shaker until the components were uniformly dispersed or dissolved. Thereafter, 14.0 parts of FC-1 talc (extender pigment, talc, manufactured by Fukuoka Talc Co., LTD.), 34.0 parts of NC-301 (inorganic antifouling agent, cuprous oxide, manufactured by NC TEC Co., Ltd.), 1.5 parts of Copper Omadine Powder (organic antifouling agent, copper pyrithione, manufactured by Lonza Japan Ltd.), 1.0 parts of TODA COLOR NM-50 (coloring pigment, red iron oxide, manufactured by TODA Pigment Co., Ltd.), 0.3 parts of BYK-018 (defoamer, mixture of defoaming polysiloxane and hydrophobic particles, manufactured by BYK Japan KK), and 150 parts of glass beads were further added to the polyethylene container and stirred for 1 hour using a paint shaker to disperse these components to obtain a mixture.

After the dispersion, 26.7 parts of the emulsion polymer 1 (Production Example 1, silyl ester-based polymer), 3.0 parts of KYOWANOL M (coalescent, 2,2,4-trimethyl-1,3-pentanediol monoisobutyrate, manufactured by KH Neochem Co., Ltd.), and 4.0 parts of DISPARLON AQ-002 (thickener, acrylic polymer, Kusumoto Chemicals, Ltd.) were added to a filtrate obtained by removing the glass beads from the mixture with a filtering net (mesh opening: 80 mesh), and the mixture was dispersed for 10 minutes using the disperser to obtain the antifouling coating composition.

### Examples 2 to 6 and Comparative Examples 1 to 9

The antifouling coating composition was prepared in the same manner as in Example 1 except that a type and a blending amount of each component were changed as shown in Table 2. Each numerical value described for each component in Table 2 represents part(s) by mass. Note that in Comparative Examples 2 to 5, since the coating material could not be favorably formed, for example, the dynamic antifouling property described later could not be evaluated. Details of the components described in Table 2 other than the components described above are as follows.

Selektope (organic antifouling agent, medetomidine, manufactured by I-Tech AB)

NOIGEN XL-400D (non-reactive nonionic surfactant, polyoxyalkylene branched decyl ether, manufactured by DKS Co. Ltd.)

### <Volatile Organic Compound (VOC) Content>

The VOC content in each of the antifouling coating compositions of Examples or Comparative Examples was calculated based on the following Formula (1) using the values of the composition specific gravity, the solid content concentration, and the moisture concentration. The meanings of the composition specific gravity, the solid content concentration, and the moisture concentration are as described above.

$$VOC content ( g / L ) = Composition specific gravity \times 1000 \times ( 100 - solid content concentration - moisture concentration ) / 100 \qquad ( 1 )$$

<Molar Ratio (Triorganosilyl Group (a):Oxyalkylene Unit (b))>

### (Pre-Treatment) Method for Extracting Water-Soluble Content

10 g of each of the antifouling coating compositions obtained in Examples and Comparative Examples was put into a centrifuge tube, about 40 g of water was added thereto and stirred well, and then centrifugation (2,100×g at 18° C. for 30 minutes) was performed. The supernatant liquid was heated and dried (at 125° C. and 1 atm for 1 hour) in an oven. Obtained solid was charged in a sample rotor having an outer diameter of 4 mm while being swollen with deuterated chloroform, and a solid NMR spectrum was measured. (Measurement) Measurement conditions for solid NMR

The solid ¹³C-NMR spectrum was measured under the following conditions.

Apparatus: AVANCEIII400 (manufactured by Bruker Japan K.K.)

Measuring method: DD-MAS method (dipole decoupling-magic angle spinning method)

Observation nucleus: ¹³C

Observation frequency: 100.6 MHz

Number of data points: 7138

Delay time: 40 seconds (30 degree pulse)

Number of integrations: 4096 times

Measurement temperature: Room temperature

Sample rotation speed: 8,000 Hz (analysis method)

### (1) Number of Moles of the Triorganosilyl Group (a)

A peak was observed around 12 ppm in the ¹³C-NMR spectrum. The peak around 12 ppm corresponds to the peak of the methine carbon in the isopropylsilyl group. Thus, 1/3 of the integral ratio (area ratio) of the peak around 12 ppm was calculated as the number of moles (relative value) of the triisopropylsilyl group. The chemical shift was corrected such that a central peak of a triplet derived from the deuterated chloroform was 77.23 ppm.

### (2) Number of Moles of the Oxyalkylene Unit (b)

A peak was observed around 70 to 76 ppm in the ¹³C-NMR spectrum. The peak around 70 to 76 ppm corresponds to a peak of the methylene carbon of the ethylene glycol structure or the methylene carbon and the methine carbon of the propylene glycol structure. Thus, 1/2 of the integral ratio (area ratio) of the peak around 70 to 76 ppm was calculated as the number of moles (relative value) of the oxyalkylene unit. The chemical shift was corrected such that a central peak of a triplet derived from the deuterated chloroform was 77.23 ppm.

(3) Calculation of the molar ratio ((a):(b))

The molar ratio ((a):(b)) of the triorganosilyl group (a) to the oxyalkylene unit (b) was calculated from the number of moles of the triorganosilyl group (triisopropylsilyl group in this example) obtained in the above (1) and the number of moles of the oxyalkylene unit obtained in the above (2).

### [Evaluation of Physical Properties of Antifouling Coating Composition and Antifouling Coating Film]

### <Storage Stability of Antifouling Coating Composition>

Each of the antifouling coating compositions of Examples or Comparative Examples was stored at 23° C. for 1 week, and then the state of the composition was visually confirmed and evaluated based on the following evaluation criteria.

### (Evaluation Criteria for Storage Stability)

Good: There is no skinning or generation of seedings, and no defect as a coating material is observed.

NG: Skinning and/or generation of seedings are observed, and defects as a coating material are observed.

### <Dynamic Antifouling Property of Antifouling Coating Film>

A sandblasted steel plate having a size of 300 mm in length, 100 mm in width, and 2.3 mm in thickness, an epoxy-based anticorrosive coating material (trade name: “BANNOH 1500”, manufactured by CHUGOKU MARINE PAINTS, LTD.), and an epoxy-based binder coating material (trade name: “CMP AC-EP”, manufactured by CHUGOKU MARINE PAINTS, LTD.) were respectively provided.

The epoxy-based anticorrosive coating material was applied onto the sandblasted steel plate by using an applicator so as to have a dry film thickness of 150 μm, and dried to form a cured coating film. Next, the epoxy-based binder coating material was applied onto the cured coating film so as to have a dry film thickness of 100 μm, and dried at 23° C. for 1 day to form a cured coating film. Then, each of the antifouling coating compositions of Examples and Comparative Examples was applied to the surface of the cured coating film of the epoxy-based binder coating material by using an applicator so as to have a dry film thickness of 150 μm, and dried at 23° C. for 7 days to form an antifouling coating film. In this way, a test plate was prepared. The obtained test plate was immersed in seawater in Kure Sea, Hiroshima Prefecture, and a water stream was generated so as to reach about 15 knots per hour using a rotating rotor. The water stream was applied to the surface of the antifouling coating film of the test plate for 12 months, and a ratio of an area of a region to which aquatic organisms adhered (hereinafter, the area is also referred to as “adhesion area”) to the surface of the antifouling coating film of the test plate was evaluated by visual observation.

### (Evaluation Criteria of Dynamic Antifouling Property Test)

5: The ratio of the adhesion area is less than 5%.
4: The ratio of the adhesion area is 5% or more and less than 20%.
3: The ratio of the adhesion area is 20% or more and less than 40%.
2: The ratio of the adhesion area is 40% or more and less than 60%.
1: The ratio of the adhesion area is 60% or more.

### <Calculation of Coating Film Consumption Degree and Gradient α>

A hard vinyl chloride plate having a size of 50 mm in length, 50 mm in width, and 1.5 mm in thickness was provided. Each of the antifouling coating compositions of Examples and Comparative Examples was applied onto the hard vinyl chloride plate by using an applicator so as to have a dry film thickness of 150 μm, and dried at 23° C. for 7 days to form an antifouling coating film. In this way, a test plate was prepared.

The obtained test plate was attached to a rotating drum installed in a thermostatic bath, the rotating drum was immersed in seawater, and rotated at a circumferential speed of 15 knots under a condition of a seawater temperature of 30° C., and the consumption degree (amount of decrease in film thickness, amount of decrease with respect to a film thickness of the antifouling coating film when the test plate is attached to the rotating drum) of the antifouling coating film after 3 months and 6 months was measured. The consumption degree of the coating film is preferably constant, and specifically, the consumption degree of the coating film was evaluated based on the following evaluation criteria for a gradient α calculated by “amount of decrease in the coating film after 6 months/amount of decrease in the coating film after 3 months”. It is preferable that α=2.0. When the gradient is large (α>>2.0), the consumption degree is too high, so that the coating film finally disappears, and the antifouling property tends to be poor. When the gradient is small (α<<2.0), the consumption degree is too low, so that elution of the antifouling agent becomes insufficient, and the antifouling property tends to be poor.

### (Evaluation Criteria of Consumption Degree Test)

5: α=1.8 or more and less than 2.2.
4: α=1.6 or more and less than 1.8, or 2.2 or more and less than 2.4.
3: α=1.4 or more and less than 1.6, or 2.4 or more and less than 2.6.
2: α=1.2 or more and less than 1.4, or 2.6 or more and less than 2.8.
1: α=1.0 or more and less than 1.2, or 2.8 or more and less than 3.0.

### <Crack Resistance of Antifouling Coating Film>

A sandblasted steel plate having a size of 150 mm in length, 70 mm in width, and 2.3 mm in thickness, the epoxy-based anticorrosive coating material (trade name: “BANNOH 1500”, manufactured by CHUGOKU MARINE PAINTS, LTD.), and the epoxy-based binder coating material (trade name: “CMP AC-EP”, manufactured by CHUGOKU MARINE PAINTS, LTD.) were respectively provided.

The epoxy-based anticorrosive coating material was applied onto the sandblasted steel plate by using an applicator so as to have a dry film thickness of 150 μm, and dried to form a cured coating film. Next, the epoxy-based binder coating material was applied onto the cured coating film so as to have a dry film thickness of 100 μm, and dried at 23° C. for 24 hours to form a cured coating film. Then, each of the antifouling coating compositions of Examples and Comparative Examples was applied to the surface of the cured coating film of the epoxy-based binder coating material by using an applicator so as to have a dry film thickness of 200 μm, and dried at 23° C. for 7 days to form an antifouling coating film. In this way, a test plate was prepared. The obtained test plate was immersed in artificial sea water at 50° C., and a coating film appearance was examined every 1 month, and this was performed for 4 months. The artificial seawater was replaced with fresh one every week. Crack resistance of the antifouling coating film was evaluated based on the following evaluation criteria.

### (Evaluation Criteria of Crack Resistance)

5: There is no abnormality at all.
4: Generation of cracks is observed in less than 10% of the total area of the coating film surface.
3: Generation of cracks is observed in 10% or more and less than 20% of the total area of the coating film surface.
2: Generation of cracks is observed in 20% or more and less than 40% of the total area of the coating film surface.
1: Generation of cracks is observed in 40% or more of the total area of the coating film surface

TABLE 2

| | Solid | | | | | | | | Compar- | Compar- |
|---|---|---|---|---|---|---|---|---|---|---|
| | content | | | | | | | | ative | ative |
| | concen- | | Exam- | Exam- | Exam- | Exam- | Exam- | Exam- | Exam- | Exam- |
| | tration | | ple | ple | ple | ple | ple | ple | ple | ple |
| | (mass %) | Component | 1 | 2 | 3 | 4 | 5 | 6 | 1 | 2 |
| NC-301 | 100 | Inorganic | 34.0 | 34.0 | 34.0 | 34.0 | 34.0 | 34.0 | 34.0 | 34.0 |
| | | antifouling | | | | | | | | |
| | | agent | | | | | | | | |
| Copper Omadine | 100 | Organic | 1.5 | 1.5 | 1.5 | 1.5 | 1.5 | 1.5 | 1.5 | 1.5 |
| Powder | | antifouling | | | | | | | | |
| | | agent | | | | | | | | |
| Selektope ® | 100 | Organic | | | | | 0.1 | | | |
| | | antifouling | | | | | | | | |
| | | agent | | | | | | | | |
| FC-1 talc | 100 | Extender | 14.0 | 14.0 | 14.0 | 14.0 | 14.0 | 14.0 | 14.0 | 14.0 |
| | | pigment | | | | | | | | |
| TODA COLOR | 100 | Coloring | 1.0 | 1.0 | 1.0 | 1.0 | 1.0 | 1.0 | 1.0 | 1.0 |
| NM-50 | | pigment | | | | | | | | |
| DISPERBYK - 194N | 57 | Wetting and | 1.0 | 1.0 | 1.0 | 1.0 | 1.0 | 1.0 | 1.0 | 1.0 |
| | | dispersing | | | | | | | | |
| | | agent | | | | | | | | |
| BYK-018 | 100 | Defoamer | 0.3 | 0.3 | 0.3 | 0.3 | 0.3 | 0.3 | 0.3 | 0.3 |
| Deionized water | 0 | | 14.5 | 14.5 | 14.5 | 14.5 | 14.4 | 11.5 | 14.5 | 14.5 |
| (Subtotal) | | | 66.3 | 66.3 | 66.3 | 66.3 | 66.3 | 63.3 | 66.3 | 66.3 |
| Emulsion Polymer 1 | 45 | Silyl ester- | 26.7 | | | | | | | |
| | | based polymer | | | | | | | | |
| Emulsion Polymer 2 | 45 | Silyl ester- | | 26.7 | | | 26.7 | | | |
| | | based polymer | | | | | | | | |
| Emulsion Polymer 3 | 45 | Silyl ester- | | | 26.7 | | | | | |
| | | based polymer | | | | | | | | |
| Emulsion Polymer 4 | 45 | Silyl ester- | | | | 26.7 | | | | |
| | | based polymer | | | | | | | | |
| Emulsion Polymer 5 | 45 | Silyl ester- | | | | | | | 26.7 | |
| | | based polymer | | | | | | | | |
| Emulsion Polymer 6 | 45 | Silyl ester- | | | | | | 26.7 | | 26.7 |
| | | based polymer | | | | | | | | |
| Emulsion Polymer 7 | 45 | Silyl ester- | | | | | | | | |
| | | based polymer | | | | | | | | |
| Emulsion Polymer 8 | 45 | Silyl ester- | | | | | | | | |
| | | based polymer | | | | | | | | |
| Emulsion Polymer 9 | 45 | Silyl ester- | | | | | | | | |
| | | based polymer | | | | | | | | |
| Emulsion Polymer 10 | 45 | Silyl ester- | | | | | | | | |
| | | based polymer | | | | | | | | |
| Emulsion Polymer 11 | 45 | Silyl ester- | | | | | | | | |
| | | based polymer | | | | | | | | |
| Emulsion 1 | 45 | Silyl ester- | | | | | | | | |
| | | based polymer | | | | | | | | |
| NOIGEN XL-400D | 65 | Non-reactive | | | | | | 3.0 | | |
| | | nonionic | | | | | | | | |
| | | surfactant | | | | | | | | |
| KYOWANOL M | 0 | Coalescent | 3.0 | 3.0 | 3.0 | 3.0 | 3.0 | 3.0 | 3.0 | 3.0 |
| DISPARLON AQ-002 | 15 | Thickener | 4.0 | 4.0 | 4.0 | 4.0 | 4.0 | 4.0 | 4.0 | 4.0 |
| (Total) | | | 100 | 100 | 100 | 100 | 100 | 100 | 100 | 100 |

| VOC (g/L) | | 50 | 50 | 50 | 50 | 50 | 50 | 50 | — |
|---|---|---|---|---|---|---|---|---|---|
| (Molar ratio) | Triorganosilyl group (a) | 43.5 | 47.6 | 48.1 | 47.8 | 47.8 | 47.3 | 50.0 | 58.8 |
| | Oxyalkylene unit (b) | 56.5 | 52.4 | 51.9 | 52.2 | 52.2 | 52.7 | 50.0 | 41.2 |

Evaluation

| | | | | | | | | |
|---|---|---|---|---|---|---|---|---|
| Storage stability | Good | Good | Good | Good | Good | Good | NG | NG |
| Dynamic antifouling property | 5 | 5 | 5 | 5 | 5 | 5 | 3 | — |
| Gradient of consumption degree | 4 | 5 | 4 | 4 | 4 | 4 | 3 | — |
| Crack resistance | 5 | 5 | 4 | 5 | 5 | 4 | 4 | — |

| | Solid | | | | | | | | |
|---|---|---|---|---|---|---|---|---|---|
| | content | | | | | | | | |
| | concen- | | Compar- | Compar- | Compar- | Compar- | Compar- | Compar- | Compar- |
| | tration | | ative | ative | ative | ative | ative | ative | ative |
| | (mass %) | Component | Example 3 | Example 4 | Example 5 | Example 6 | Example 7 | Example 8 | Example 9 |
| NC-301 | 100 | Inorganic | 34.0 | 34.0 | 34.0 | 34.0 | 34.0 | 34.0 | 34.0 |
| | | antifouling | | | | | | | |
| | | agent | | | | | | | |
| Copper Omadine | 100 | Organic | 1.5 | 1.5 | 1.5 | 1.5 | 1.5 | 1.5 | 1.5 |
| Powder | | antifouling | | | | | | | |
| | | agent | | | | | | | |
| Selektope ® | 100 | Organic | | | | | | | |
| | | antifouling | | | | | | | |
| | | agent | | | | | | | |
| FC-1 talc | 100 | Extender | 14.0 | 14.0 | 14.0 | 14.0 | 14.0 | 14.0 | 14.0 |
| | | pigment | | | | | | | |
| TODA COLOR | 100 | Coloring | 1.0 | 1.0 | 1.0 | 1.0 | 1.0 | 1.0 | 1.0 |
| NM-50 | | pigment | | | | | | | |
| DISPERBYK - 194N | 57 | Wetting and | 1.0 | 1.0 | 1.0 | 1.0 | 1.0 | 1.0 | 1.0 |
| | | dispersing | | | | | | | |
| | | agent | | | | | | | |
| BYK-018 | 100 | Defoamer | 0.3 | 0.3 | 0.3 | 0.3 | 0.3 | 0.3 | 0.3 |
| Deionized water | 0 | | 14.5 | 14.5 | 14.5 | 14.5 | 14.5 | 14.5 | 8.5 |
| (Subtotal) | | | 66.3 | 66.3 | 66.3 | 66.3 | 66.3 | 66.3 | 60.3 |
| Emulsion Polymer 1 | 45 | Silyl ester- | | | | | | | |
| | | based polymer | | | | | | | |
| Emulsion Polymer 2 | 45 | Silyl ester- | | | | | | | |
| | | based polymer | | | | | | | |
| Emulsion Polymer 3 | 45 | Silyl ester- | | | | | | | |
| | | based polymer | | | | | | | |
| Emulsion Polymer 4 | 45 | Silyl ester- | | | | | | | |
| | | based polymer | | | | | | | |
| Emulsion Polymer 5 | 45 | Silyl ester- | | | | | | | |
| | | based polymer | | | | | | | |
| Emulsion Polymer 6 | 45 | Silyl ester- | | | | | | | 26.7 |
| | | based polymer | | | | | | | |
| Emulsion Polymer 7 | 45 | Silyl ester- | 26.7 | | | | | | |
| | | based polymer | | | | | | | |
| Emulsion Polymer 8 | 45 | Silyl ester- | | 26.7 | | | | | |
| | | based polymer | | | | | | | |
| Emulsion Polymer 9 | 45 | Silyl ester- | | | 26.7 | | | | |
| | | based polymer | | | | | | | |
| Emulsion Polymer 10 | 45 | Silyl ester- | | | | 26.7 | | | |
| | | based polymer | | | | | | | |
| Emulsion Polymer 11 | 45 | Silyl ester- | | | | | 26.7 | | |
| | | based polymer | | | | | | | |
| Emulsion 1 | 45 | Silyl ester- | | | | | | 26.7 | |
| | | based polymer | | | | | | | |
| NOIGEN XL-400D | 65 | Non-reactive | | | | | | | 6.0 |
| | | nonionic | | | | | | | |
| | | surfactant | | | | | | | |
| KYOWANOL M | 0 | Coalescent | 3.0 | 3.0 | 3.0 | 3.0 | 3.0 | 3.0 | 3.0 |
| DISPARLON AQ-002 | 15 | Thickener | 4.0 | 4.0 | 4.0 | 4.0 | 4.0 | 4.0 | 4.0 |
| (Total) | | | 100 | 100 | 100 | 100 | 100 | 100 | 100 |

| VOC (g/L) | | — | — | — | 50 | 50 | 150 | 50 |
|---|---|---|---|---|---|---|---|---|
| (Molar ratio) | Triorganosilyl group (a) | 58.8 | 58.8 | 49.1 | 50.7 | 48.8 | 47.8 | 39.4 |
| | Oxyalkylene unit (b) | 41.2 | 41.2 | 50.9 | 49.3 | 51.2 | 52.2 | 60.6 |

Evaluation

| | | | | | | | |
|---|---|---|---|---|---|---|---|
| Storage stability | NG | NG | NG | NG | NG | Good | Good |
| Dynamic antifouling property | — | — | — | 2 | 4 | 1 | 1 |
| Gradient of consumption degree | — | — | — | 2 | 2 | 1 | 1 |
| Crack resistance | — | — | — | 5 | 4 | 1 | 2 |

What is claimed is:

1. An antifouling coating composition comprising:
a silyl ester-based polymer; and water, wherein
the silyl ester-based polymer has a triorganosilyl group, and
the antifouling coating composition has a volatile organic compound (VOC) content of 100 g/L or less, an oxyalkylene unit is present in the antifouling coating composition, and a molar ratio ((a):(b)) of a triorganosilyl group (a) to an oxyalkylene unit (b) measured by ¹³C-NMR with respect to the antifouling coating composition is 40.0:60.0 to 48.5:51.5.

2. The antifouling coating composition according to claim 1, wherein the oxyalkylene unit constitutes a poly (oxyalkylene) structure.

3. The antifouling coating composition according to claim 1, wherein the oxyalkylene unit is at least one selected from an oxyethylene unit and an oxypropylene unit.

4. The antifouling coating composition according to claim 1, wherein the silyl ester-based polymer includes a structural unit (a-1) derived from a polymerizable monomer (a1) represented by the following Formula (a1): 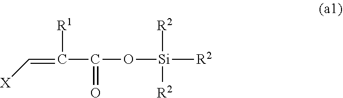
(In Formula (a1),
R¹ is a hydrogen atom or a methyl group,
each R² is independently a monovalent organic group having 1 to 20 carbon atoms optionally having a hetero atom, provided that an atom bonded to a silicon atom (Si) in Formula (a1) in the organic group is a carbon atom,
X is a hydrogen atom or a group represented by R³—O—C(═O)—, R³ is a hydrogen atom, a monovalent organic group having 1 to 20 carbon atoms optionally having a hetero atom, or a silyl group represented by (R⁴)3Si—, and each R4 is independently a monovalent organic group having 1 to 20 carbon atoms optionally having a hetero atom, provided that an atom bonded to the silicon atom (Si) contained in the silyl group in the organic group is a carbon atom.]

5. The antifouling coating composition according to claim 4, wherein the silyl ester-based polymer has a content ratio of the structural unit (a-1) of 30 mass % or more.

6. The antifouling coating composition according to claim 1, wherein the triorganosilyl group is a trialkylsilyl group.

7. The antifouling coating composition according to claim 6, wherein the trialkylsilyl group is a triisopropylsilyl group.

8. The antifouling coating composition according to claim 1, wherein a content ratio of the silyl ester-based polymer is 5 to 30 mass % in 100 mass % of the solid content of the antifouling coating composition.

9. The antifouling coating composition according to claim 1, further comprising cuprous oxide.

10. The antifouling coating composition according to claim 1, further comprising an organic antifouling agent.

11. The antifouling coating composition according to claim 1, wherein a content ratio of water in the antifouling coating composition is 10 to 50 mass %.

12. An antifouling coating film made of the antifouling coating composition according to claim 1.

13. An antifouling substrate comprising:
a substrate; and
the antifouling coating film according to claim 12 provided on the substrate.

14. A method for producing an antifouling substrate, comprising:
a step of obtaining an applied body or an impregnated body by applying or impregnating the antifouling coating composition according to claim 1 to a substrate; and
a step of drying the applied body or the impregnated body.
